(19) United States
(12) Patent Application Publication
(10) Pub. No.: US 2021/0404832 A1
(43) Pub. Date: Dec. 30, 2021

(54) Systems and Methods for Generating Movement Insights

(71) Applicant: Google LLC, Mountain View, CA (US)

(72) Inventor: Haroon Baig, Zurich (CH)

(21) Appl. No.: 16/911,910

(22) Filed: Jun. 25, 2020

(51) Int. Cl. G01C 21/36; G01C 21/34

(52) U.S. Cl. CPC G01C 21/3617; G01C 21/3469; G01C 21/3423

(57) ABSTRACT

The present disclosure is directed to systems for generating travel improvements. In particular a computer system can access historical trip information associated with a user. The computer system can select one or more trips represented in the historical trip information, the one or more trips comprising data describing an origination point, a destination point, and an actual route traveled between the origination point and the destination point. The computer system can generate a recommended route from the origination point to the destination point. The computer system can compare the actual route and the recommended route to identify one or more areas of trip improvement. The computer system can transmit a recommendation for display to a user including information associated with the one or more areas of trip improvement.

### FIELD

The present disclosure relates generally to navigation. More particularly, the present disclosure relates to calculating route improvements for trips associated with a user.

### BACKGROUND

As computing technology has improved, the number of computing services offered to users has also increased. Portable computing devices, such as smartphones, allow users to assess navigation services while travelling. Specifically, users can request turn-by-turn directions from one location to another location. To facilitate the navigation services, the user can allow location information from their personal computing device to a remote server associated with the navigation service.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can include accessing historical trip information associated with a user. The method can include selecting one or more trips represented in the historical trip information, the one or more trips comprising data describing an origination point, a destination point, and an actual route traveled between the origination point and the destination point. The method can include generating a recommended route from the origination point to the destination point. The method can include comparing the actual route and the recommended route to identify one or more areas of trip improvement. The method can include transmitting a recommendation for display to a user including information associated with the one or more areas of trip improvement.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example client-server environment according to example aspects of the present disclosure.

FIG. 2 depicts a computing system for identifying route improvements for a user according to example aspects of the present disclosure.

FIG. 3 depicts a block diagram illustrating an example system for identifying route improvements for a user according to example aspects of the present disclosure.

FIGS. 4A-4D depicts an example user interface for displaying one or more route improvements to a user according to example aspects of the present disclosure.

FIG. 5 depict a flowchart illustrating an example method for identifying route improvements for a user according to example embodiments of the present disclosure.

### DETAILED DESCRIPTION

Generally, the present disclosure is directed to a system for generating insights for users that describe how alternate routes for particular trips can result in one or more potential improvements. To do so, an insight generation system can access historical trip information for a particular user. The historical trip information can include information that describes one or more trips taken by the user based on data received from a computing device associated with the user. Based on the accessed historical trip information, the insight generation system can select one or more trips represented in the historical trip information. A trip can be represented as an origination point, a destination point, and an actual route traveled by the user between the two points.

Once the one or more trips have been selected, the insight generation system can generate a recommended route that would have been suggested to the user, had the user requested that a navigation service associated with the insight generation system generate a route between the origination point and the destination point at the time of the trip. The insight generation system can compare the actual route(s) taken for the one or more trips to the recommended route generated by the navigation service to determine one or more potential areas of improvement. To determine one or more areas of improvement, the insight generation system can generate costs for the actual routes and the recommended routes using one or more units of measurement (e.g., time, distance, carbon emissions generated, calories, price, or the like). Each area of improvement can be represented by a specific unit of measurement. For example, if time is the area of improvement, the unit of measurements can be minutes or seconds.

The insight generating system can determine a difference between the cost for the actual route and the recommended route. The insight generation system can determine whether the difference between the cost for the actual route and the recommended route exceeds a threshold difference amount. If so, the insight generation system can transmit an insight recommendation to a user computing device associated with the user for display. The insight recommendation can describe the advantages of the suggested route for future trips. The insight recommendation can represent one area of improvement that can be improved by using routes recommended by a navigation system associated with the insight generation system.

For example, a user can have a regular commute between work and home. The information for each of these trips can be stored in the historical trip database. The insight generation system can access the trip information in the historical trip database and identify that the user commonly follows a particular route between work and home while making this commute. Once the insight generation system determines the actual route taken by the user between home and work, the insight generation system can generate a recommended route using a navigation system associated with the insight generation system. The insight generation system can then select one or more areas of trip improvement. In some examples, the key area of trip improvement will be travel time between the two points. In other examples, the insight generation system can access a user profile database to determine a unit of measurement that is of interest to the user.

For example, the insight generation system can determine that a particular user is primarily interested in reducing the carbon emissions produced while traveling. The insight generation system can calculate the amount of carbon produced by the user on the actual route and compare it to a calculated amount of carbon produced by the user while following the recommended route. If the difference between the carbon produced in the actual route and the estimated amount of carbon produced in the recommended route exceeds a difference threshold, the insight generation system can transmit a message to a computing device associated with a user for display. The message can include information detailing the amount of carbon production reduction that would occur as a result of following the recommended route. For example, if the user travels a specific route using an automobile on their daily commute and the insight generation system determines that traveling by a public transportation system would result in significant carbon emission savings, the insight generation system can notify the user that following a recommended route generated by the navigation system will result in significant saving with respect to carbon emissions.

More specifically, an insight generation system can be associated with a navigation system that provides traveling directions (e.g., turn by turn instructions) to requesting users. The navigation system can be implemented by a server computing system that includes one or more processors, memory, and one or more communication interfaces. The server computing system can receive requests for navigation services, use map data to generate recommended routes, and transmit the recommended routes to the requesting client computing systems.

The server computing system can include an insight generation system. The insight generation system can provide one or more insights to users by accessing historical trip information and selecting one or more past trips for a particular user. Once one or more past trips have been selected, the server computing system can generate a recommended path from the origination point of the selected trip(s) to the destination point of the selected trip(s). The actual route recorded in the historical trip database can be compared to the recommended route generated by the server computing system (e.g., the navigation system).

To do so, the insight generation system can calculate the cost associated with each route using one or more units of measurement including, but not limited to, time, distance, price, calories burned, and/or carbon emissions produced. Based on that comparison, the insight generation system can transmit, to a user computing system, an insight notification that describes the improvement of the route in terms of the unit of measurement used to calculate the cost of each route. For example, the insight notification can describe the total amount of time that would have been saved, the reduction in estimated cost, the number of calories burned, and so on. In this way, the server computing system can inform the user of the benefits of using the navigation system to plan future trips and thereby encourage the user to use the navigation system in the future.

One or more client systems can be connected to the server system via a communication network. Each client system can be a personal electronic device such as a personal computer, a smartphone, a tablet computer, or another electronic device. The one or more client systems can include one or more client applications. In some examples, the client applications can include a dedicated navigation application that connects to the server computing system to submit requests, receive responses, and receive insight suggestions.

In some examples, the insight generation system can access trip data from the historical trip database. In some examples, the insight generation system can access historical trip information in response to a particular event. For example, an insight generation system can begin the process of providing insights by accessing historical trip information on a regular schedule (e.g., a monthly or weekly schedule). In another example, the insight generation system can begin the process of providing insights at the end of a trip taken by a user. Thus, the insight generation system can begin providing insights when it detects that a trip has recently concluded.

The insight generation system can also initiate the process for providing insights in response to a user search or request. For example, if a user submits a search query requesting additional information about reducing their carbon footprint, the insight generation system can begin analyzing historical trip information to determine one or more trips in which the user can reduce their carbon footprint.

The insight generation system can analyze the historical trip information received from the historical trip database. The insight generation system can select from the historical information one or more trips based on one or more criteria. For example, the insight generation system can select the most recent trip completed by a user. In some examples, the most recent trip can be identified based on an analysis of location data received from a computing device associated with the user. For example, once a user arrives at a particular destination and remains in or around that destination for a particular period of time, the insight generation system can determine that the trip has been completed.

The insight generation system can determine that a user has a regular trip that they make with high frequency (e.g., a commute trip). To make this determination, the insight generation system can identify routes with a common origination point, destination point, and route (allowing for a threshold amount of variance). Once these identified routes are grouped, the most commonly occurring routes (e.g., the greatest number of routes with a similar origination point, destination point, and route) can be categorized as a regular route (e.g., a commute can be a type of regular route). Additionally, trips can be identified as associated with a regular route based on the time of day that the trips occur (e.g., trips that occur within a similar time frame each day may be more likely to be associated). A user can supply information that identifies regular trips that the user makes (e.g., by entering their home and work addresses to the navigation application).

The insight generation system can determine for the selected one or more trips the mode of transportation employed by the user while taking that trip. For example, the insight generation system can determine a route taken by the user from the origination point to the destination point. The insight generation system can compare this route to known modes of transportation. For example, if the route follows roads commonly used by automobiles, the insight generation system can determine that the mode of transportation is an automobile. However, if the route takes a path not available to an automobile, such as through a public park with no accessible roads that automobiles can travel, the insight generation system can determine that the user is employing a different mode of transportation such as walking or riding a bicycle. Similarly, if the route follows a path associated with one or more modes of public transportation, the insight generation system can determine that the user is using public transportation for the trip.

The insight generation system can calculate the speed of the user at one or more points along the trip. Based on this average speed, the insight generation system can estimate the mode of transportation. For example, a user that is walking will generally travel at a lower rate of speed than a user that is riding a bicycle or driving a vehicle. In some examples, the mode of transportation can be estimated based on user interest data or user-provided data or the stopping patterns associated with the mode of transportation (e.g., if the stops are associated with predetermined stops for public transportation).

Once one or more trips have been selected, the insight generation system can determine the origination point and destination point for the selected trips. As noted above, in situations in which more than one trip is selected the insight generation system can determine an average or typical origination point and an average or typical destination for the more than one trip. The insight generation system can generate a recommended route from the origination point (or the average origination point) to the destination point (or the average destination point). In some examples, this recommended route can be generated by an existing navigation system. In some examples, the recommended route can be generated using traffic data that existed when the historical trip was taken (or the average expected traffic on the average route). Historical traffic data can be stored in a database at the insight generation system or the navigation system.

In some examples, the insight generation system can generate a plurality of recommended routes from the origination point to the destination point with each generated route using a different mode of transportation. Modes of transportation can include automobiles, public transportation, airplanes, walking, bicycles, or any other mode of transportation that is possible.

Once one or more recommended routes have been generated, the insight generation system can compare the actual route for the one or more trips to the one or more recommended routes to determine whether any of the recommended routes result in a significant improvement in one or more categories of measurement. The insight generation system can generate a first cost for the actual route and one or more second costs for one or more recommended routes. Each cost can be generated by selecting a unit of measurement and using that unit of measurement to determine the cost of the route.

Units of measurement can include time elapsed on the trip, distance traveled, cost, calories burned, carbon emissions produced, etc. For example, if the selected unit of measurement is the time elapsed while traveling during the trip, the cost can be a representation of the total time estimated for the user to travel from the origination point to the destination point. It should be noted that costs can be calculated based on the conditions that would have existed at the time that the trip was actually taken. Thus, the costs for both the actual trip and the one or more recommended trips can be associated with the same set of conditions. The conditions present in a given geographic area (e.g., the area of the origination and destination point) can be stored in the historic trip information database or another database accessible to the insight generation system.

The insight generation system can select a specific unit of cost measurement for a particular trip or group of trips. In some examples, the most popular cost measurement for a route can be the time needed to traverse the route. As such, the insight generation system can primarily use this measurement to determine the cost of a particular route. In other examples, the insight generation system can select a unit of measurement based on the user for which the insight is being generated.

For example, the insight generation system can access a user profile database that can include user-submitted information, search history information, and a web-browsing history, but only with appropriate user permission. Similarly, the historical trip information may be gathered with the express consent of the users. Similarly, insights for potential improvements to trips may only be generated based on the approval of the user for whom the insights are being generated.

Further to the descriptions above, a user may be provided with controls allowing the user to make an election as to both if and when systems, programs, or features described herein may enable collection of user information (e.g., information about a user's current and past locations, activities, profession, or a user's preferences), and if the user is sent insights, content, or communications from a server. In addition, any collected data may be treated in one or more ways before it is stored or used, so that personally identifiable information is removed. For example, a user's identity may be treated so that no personally identifiable information can be determined for the user, so that a particular location of a user cannot be determined. Thus, the user may have control over what information is collected about the user, how that information is used, and what information is provided to the user.

By analyzing this information stored in the user profile, the insight generation system can select a unit of measurement of particular interest to a particular user. For example, a given user may be primarily interested in increasing the number of calories burned while traveling a given route. Thus, the insight generation system could primarily focus on measuring costs based on calories burned for that particular user.

The insight generation system can compare the calculated first costs for the actual route with calculated second costs for the one or more recommended routes. As noted above, the mode of transportation associated with the actual route may be different from the mode of transportation associated with one or more of the recommended routes. Thus, the insight generation system can determine a cost difference between the actual route and the one or more recommended routes. A cost difference can be calculated for a plurality of different units of measurement to identify the unit of measurement with the most cost reduction for a recommended route.

The insight generation system can determine whether the cost difference between the actual route and a particular recommended route exceeds a threshold difference value. If the cost difference between the first cost (associated with the actual route) and the second cost (associated with a particular recommended route) does not exceed the threshold difference value, the insight generation system can determine that no suggested alterations need to be suggested in this case. In another example, the insight generation system can use a different unit of measurement to identify another area in which cost savings can be realized.

In some examples, the insight generation system can determine whether the recommended route is possible for the user to take. For example, a walking route may save a significant amount of carbon and may burn a significant number of additional calories. However, if the time needed to travel the route adds three hours to the total journey time, the insight generation system can disregard the recommended route as non-viable. The mode of transportation for a particular route can limit the degree to which it is considered a viable alternative for the actual route. For this reason, even if the unit of measurement is not the time elapsed during the trip, the insight generation system can discard any recommended routes that increase the total time taken by more than a threshold value (e.g., more than 10 minutes added to a route, a percentage of the total time, or other method of determining a threshold value). Additionally, particular modes of transportation can be ignored for trips that exceed some threshold value. Thus, walking may not be considered for any trip over a certain distance (e.g., 1 mile, 10 miles, or another value) and bicycling may not be considered for any trip over a certain distance (e.g., more than 50 miles).

If the insight generation system determines that a particular recommended route can result in an improvement for one or more units of measurement and remain a viable route, the insight generation system can transmit a message to a computing device associated with the user for display. The message can include information describing one or more savings (in the selected unit of measurement) to be expected if the user had used a recommended route rather than the actual route that the user took. In this way, the insight generation system can incentivize users to use the navigation system associated with the insight generation system to plan future trips.

In some examples, the recommendation message can be sent as an email (e.g., as part of a regularly delivered email newsletter). For example, the navigation system can deliver periodic newsletter emails to users and can include information about potential cost savings within the email. Similarly, the insight navigation system can transmit recommendation messages as text to users such that the message will be displayed on the user's computing device.

A user computing device may include a dedicated navigation application associated with the navigation system. In some examples, the insight information can be displayed to the user when they open the navigation app. In some examples, a user may enter a search associated with one of the more units of measurement into a search engine. In response, the insight generation system can display, as part of one of the search results, a suggested route improvement that will be associated with the search query. For example, if a user submits a search query including the question “how can I reduce my carbon footprint.” the insight generation system can display one or more suggested route alterations that will have the desired effect for the user.

With reference to the figures, example embodiments of the present disclosure will be discussed in further detail.

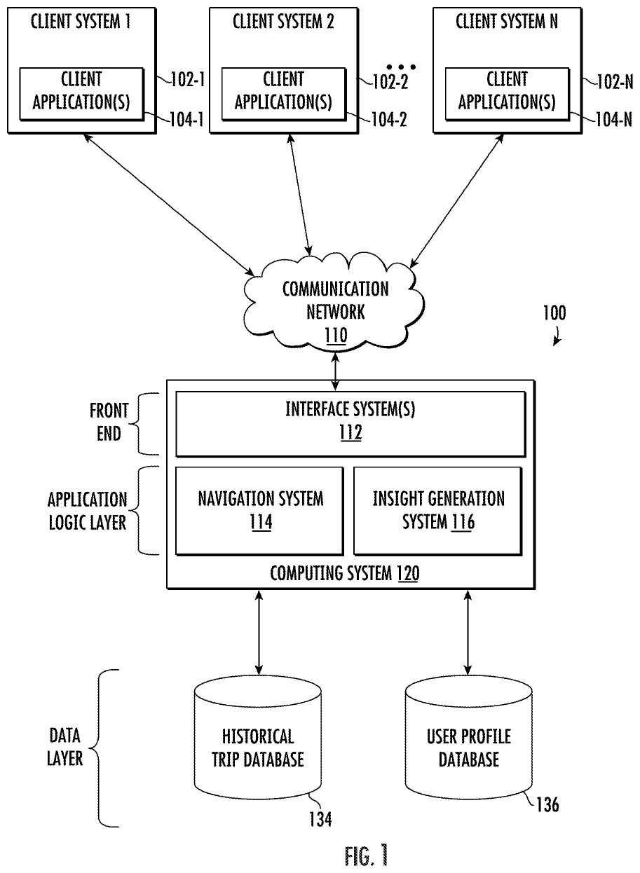

FIG. 1 depicts an example client-server environment according to example embodiments of the present disclosure. The client-server system environment 100 includes one or more client systems (102-1, 102-2, and 102-N) and the computing system 120. One or more communication networks 110 can interconnect these components. The communication networks 110 may be any of a variety of network types, including local area networks (LANs), wide area networks (WANs), wireless networks, wired networks, the Internet, personal area networks (PANs), or a combination of such networks. It should be noted that FIG. 1 includes a plurality of client systems, each labeled with a distinctive reference number (102-1, 102-2, and 102-N). However, when referring to a generic client system, rather than a specific depicted client system, the general reference number 102 can be used.

A client system 102 can be an electronic device, such as a personal computer (PC), a laptop, a smartphone, a tablet, a mobile phone, a wearable computing device, an electrical component of a vehicle, or any other electronic device capable of communication with the communication network 110. A client system 102 can include one or more client application(s) 104 such as search applications, communication applications, navigation applications, productivity applications, game applications, word processing applications, or any other useful applications. The client application(s) 104 can include a web browser. The client system 102 can use a web browser to send and receive requests to and from the computing system 120.

In some examples, a client system 102 can include one or more sensors that can be used to determine the current location of the client system 102. This information can be transmitted, with the user's permission, the location of the client system 102 to the computing system 120. This data can be stored in the historical trip database 134 or an associated database.

As shown in FIG. 1, the computing system 120 is generally based on a three-tiered architecture, consisting of a front-end layer, application logic layer, and data layer. As is understood by skilled artisans in the relevant computer and Internet-related arts, each component shown in FIG. 1 can represent a set of executable software instructions and the corresponding hardware (e.g., memory and processor) for executing the instructions. To avoid unnecessary detail, various components and engines that are not germane to conveying an understanding of the various examples have been omitted from FIG. 1. However, a skilled artisan will readily recognize that various additional components and engines may be used with a computer system 120, such as that illustrated in FIG. 1, to facilitate additional functionality that is not specifically described herein. Furthermore, the various components depicted in FIG. 1 may reside on a single server computer or may be distributed across several server computers in various arrangements. Moreover, although the computer system 120 is depicted in FIG. 1 as having a three-tiered architecture, the various example embodiments are by no means limited to this architecture.

As shown in FIG. 1, the front end consists of an interface system(s) 112, which receives communications from various remote systems 102 (e.g., 102-1, 102-2, or 102-N) and communicates appropriate responses to the client systems 102. For example, the interface system(s) 112 may receive requests in the form of Hypertext Transfer Protocol (HTTP) requests, or other web-based, application programming interface (API) requests. The computer system 102 may be executing conventional web browser applications or applications that have been developed for a specific platform to include any of a wide variety of computing devices and operating systems.

As shown in FIG. 1, the data layer can include a historical trip database 134 and a user profile database 136. The historical trip database 134 can include data describing trip data for a plurality of users over a period of time. In some examples, the historical trip database 134 can include, for each user, a plurality of trips, each trip including an origination point, a destination point, and a route between the origination point and the destination point. In some examples, the trips are represented as a series of points, each point representing the position of a computing device associated with a user at a particular time interval. In other examples, the location data can be processed before being entered into the historical trip database such that the trips are represented only with the origination point, destination point, and route data.

The user profile database 136 can include data associated with a plurality of users including but not limited to, data describing a user's interests, locations associated with the user (e.g., a designated home location or work location), information submitted by the user (e.g., demographic data, occupation data, and so on), user transportation information, and so on. User interest profiles can be generated based on user search history data, user purchase history data, user travel data, user browsing history, and so on.

The application logic layer can include application data that can provide a broad range of other applications and services that allow users to access or receive geographic data for navigation or other purposes. The application logic layer can include a navigation system 114 and an insight generation system 116. The navigation system 114 can be implemented by a computing system 120 that includes one or more processors, memory, and one or more communication interfaces. The navigation system 114 can receive requests for navigation services, use map data to generate recommended routes, and transmit the recommended routes to the requesting client computing systems 102.

The insight generation system 116 can provide one or more insights to users by accessing historical trip information from the historical trip database 134 and selecting one or more past trips for a particular user. Once one or more trips have been selected, the computing system 120 can generate a recommended path from the origination point of the selected trip(s) to the destination point of the selected trip(s). The actual route recorded in the historical trip database 134 can be compared to the recommended route generated by the computing system 120 (e.g., the navigation system 114).

To do so, the insight generation system 116 can calculate the cost associated with each route using one or more units of measurement including, but not limited to, time, distance, price, calories burned, and/or carbon emissions produced. Based on that comparison, the insight generation system 116 can transmit, to a client system 102, an insight notification that describes the improvement of the route in terms of the unit of measurement used to calculate the cost of each route. For example, the insight notification can describe the total amount of time that would have been saved, the reduction in estimated cost, the number of additional calories burned, and so on. In this way, the computing system 120 can inform the user of the benefits of using the navigation system 114 to plan future trips and thereby encourage the user to use the navigation system 114 in the future.

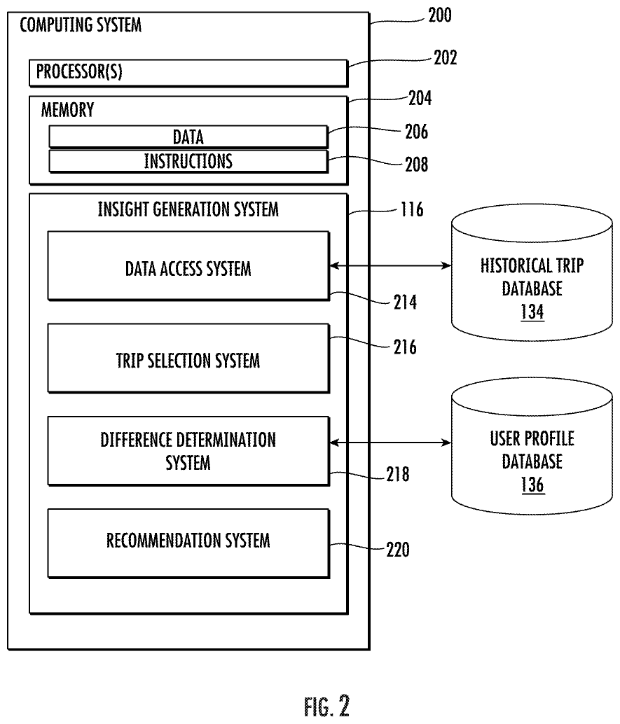

FIG. 2 depicts a computing system for identifying route improvements for a user according to example aspects of the present disclosure. As illustrated, FIG. 2 includes a computing system 200 that can be used to analyze and extract data from form-like documents. The computing system 200 can include one or more processor(s) 202, memory 204, and a document analysis system 116.

The one or more processor(s) 202 can be any suitable processing device, such as a microprocessor, microcontroller, integrated circuit, or other suitable processing device. The memory 204 can include any suitable computing system or non-transitory computer-readable media, including, but not limited to, non-transitory computer-readable media, RAM. ROM, hard drives, flash drives, or another memory devices. The memory 204 can store information accessible by the one or more processor(s) 202, including instructions 208 that can be executed by the one or more processor(s) 202 and data 206 needed to execute the instructions. The instructions 208 can be any set of instructions that when executed by the one or more processor(s) 202, cause the one or more processor(s) 202 to provide the desired functionality.

In particular, in some devices, memory 204 can store instructions for implementing the insight generation system 116. The computing system 200 can implement the insight generation system 116 to execute aspects of the present disclosure, including generating insights for improving trips taken by a user.

It will be appreciated that the term “system” can refer to specialized hardware, computer logic that executes on a more general processor, or some combination thereof. Thus, a system can be implemented in hardware, application-specific circuits, firmware and/or software controlling a general-purpose processor. In one embodiment, the system can be implemented as program code files stored on the storage device, loaded into memory, and executed by a processor or can be provided from computer program products, for example computer-executable instructions, that are stored in a tangible computer-readable storage medium such as RAM, hard disk or optical or magnetic media.

Memory 204 can also include data 206 that can be retrieved, manipulated, created, or stored by the one or more processor(s) 202. In some example embodiments, such data can be accessed and used as input to the insight generation system 116. In some examples, the memory 204 can include data used to perform one or more processes and instructions that describe how those processes can be performed.

In some examples the insight generation system 116 can include a data access system 214, a trip selection system 216, a difference determination system 218, and a recommendation system 220. Each component included in the insight generation system 116 can be implemented as a distinct system or as one component of an overall system. In some examples, the computing system 200 can be connected to a historical trip database 134 that includes data describing a plurality of past trips associated with a plurality of different users.

The data access system 214 can access data in the historical trip database for a particular user. In some examples, the trip selection system 216 can select a particular user to generate insights for and access historical trip data for that user. In some examples, the insight generation system 116 can begin the process of generating insights when a particular trip is completed. For example, if a user submits location data to the insight generation system 116 that indicates the user has stopped moving (e.g., the periodic location updates stay within threshold distance for a particular amount of time), the trip selection system 216 may select the recently completed trip and begin to generate insights. It should be noted that the insight generation system 116 can generate insights for trips that did not employ the navigation system (e.g., navigation system 114 in FIG. 1) to generate a route for the trip. In this way, the insights generated can represent the difference between the actual route taken for the trip and the recommended route that would be generated by the navigation system (e.g., navigation system 114 in FIG. 1).

In other examples, the insight generation system 116 can periodically evaluate routes commonly taken by a particular user. For example, the insight generation system 116 can identify a commute from a user's home to a work location. The trip selection system 216 can select a plurality of trips during a particular period and generate an average commute route.

Once the trip selection system 216 has selected one or more historical trips, the difference determination system 218 can identify one or more differences between the actual route for the selected one or more historical trips and the recommended route for the one or more selected historical trips. In some examples, the insight generation system 116 can employ the navigation system (e.g., navigation system 114 in FIG. 1) to determine a recommended route for the selected one or more trips. Once a recommended route has been generated, the difference determination system 218 can calculate a difference between the actual route taken and the recommended route based on one or more units of measurement. The unit of measurement can include a specific unit of measurement that can be used to evaluate the goodness of a trip. In many cases, the total time taken for the trip can be a key measurement of the goodness of the trip. However, other units of measurement, such as total distance traveled, money used, calories burned, and carbon emissions produced can also be used to evaluate a trip.

The difference determination system 216 can calculate, for each potential unit of measurement, a difference between the cost associated with the actual route and a cost associated with the recommended route, wherein cost in this case refers to an amount expended in the selected unit of measurement. In some examples, the difference determination system 216 can access a user profile database 136 to determine one or more interests associated with the user. The difference determination system 216 can select a unit of measurement based on the interests associated with the user. For example, some users are more interested in reducing their carbon footprint than in saving extra time. Similarly, other users may be interested in increasing the number of calories burned for a particular trip.

The difference determination system 216 can identify one or more units of measurement for which the difference between the actual and the recommended exceeds a previous thermal threshold. Thus, if the difference between the actual route is minimal, the difference determination system 216 will disregard the unit of measurement as a potential insight to be recommended to a user.

The difference determination system 216 can transmit one or more calculated differences to the recommendation system. The recommendation system can generate a message to transmit an insight to the user for display. The insight can identify a particular trip that the user has recently taken, and note the savings the user would experience had they followed a route recommended by the navigation system. In this way, users can be alerted about one or more situations in which using the navigation system will result in a better trip experience. This can encourage users to employ the route navigation system more frequently.

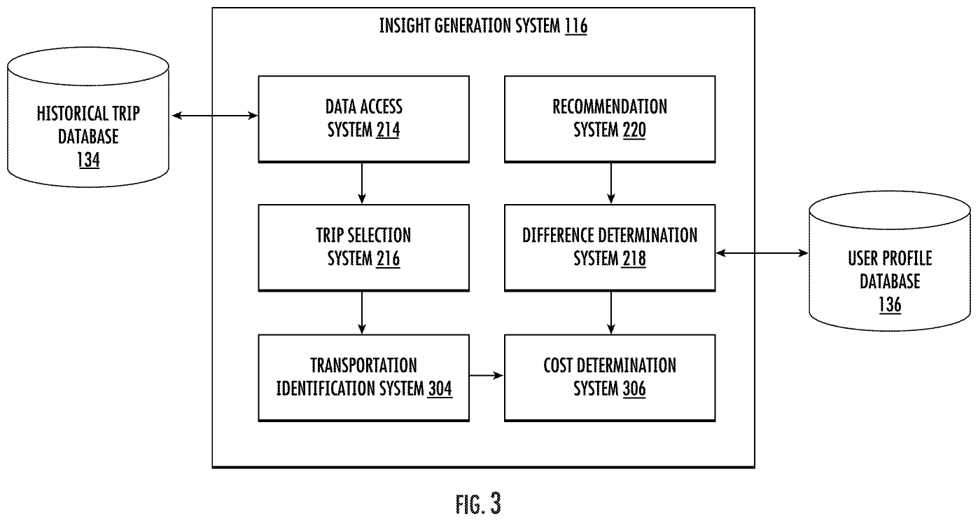

FIG. 3 depicts a block diagram illustrating an example insight generation system 116 for identifying route improvements for a user according to example aspects of the present disclosure. The insight generation system 116 can include a data access system 214, a trip selection system 216, a transportation identification system 304, a cost determination system 306, a difference determination system 218, and a recommendation system. The insight generation system 116 can access data stored in a historical trip database 134 and a user profile database 136.

The data access system 214 can access trip data from the historical trip database 134. In some examples, the data access system 214 can access historical trip information in response to a particular event. For example, the data access system 214 can begin the process of providing insights by accessing historical trip information on a regular schedule (e.g., a monthly or weekly schedule). In another example, the data access system 214 can begin the process of providing insights at the end of a trip taken by a user. Thus, the insight generation system 116 can begin providing insights when it detects that a trip has recently concluded.

The insight generation system 116 can also initiate the process for providing insights in response to a user search or request. For example, if a user submits a search query requesting additional information about reducing their carbon footprint, the insight generation system 116 can begin analyzing historical trip information to determine one or more trips in which the user can reduce their carbon footprint.

The insight generation system 116 can analyze the historical trip information received from the historical trip database. The trip selection system 216 can select from the historical information one or more trips based on one or more criteria. For example, the trip selection system 216 can select the most recent trip completed by a user. In some examples, the most recent trip can be identified based on an analysis of location data received from a computing device associated with the user (e.g., client system 102 in FIG. 1). For example, once a user arrives at a particular destination and remains in or around that destination for a particular period of time, the trip selection system 216 can determine that the trip has been completed.

The trip selection system 216 can determine that a user has a recurring trip that the user makes regularly based on a discernible schedule (e.g., a commute trip). To make this determination, the trip selection system 216 can identify routes with a common origination point, destination point, and route (allowing for a threshold amount of variance). Once these identified routes are grouped, the most commonly occurring routes (e.g., the greatest number of routes with a similar origination point, destination point, and route) can be categorized as a regular route (e.g., a commute can be a type of regular route). In addition, trips can be identified as associated with a regular route based on the time of day that the trips occur (e.g., trips that occur within a similar time frame each day may be more likely to be associated). In addition, a user can supply information that identifies regular trips that the user makes (e.g., by entering their home and work addresses to the navigation application).

The transportation identification system 304 can determine for the selected one or more trips, the mode of transportation employed by the user while taking that trip. For example, the transportation identification system 304 can determine a route taken by the user from the origination point to the destination point. The transportation identification system 304 can compare this route to known modes of transportation. For example, if the route follows roads commonly used by automobiles, the transportation identification system 304 can determine that the mode of transportation is an automobile. However, if the route takes a path not available to an automobile, such as through a public park with no accessible roads that automobiles can travel, the transportation identification system 304 can determine that the user is employing a different mode of transportation such as walking or riding a bicycle. Similarly, if the route follows a path associated with one or more modes of public transportation, the transportation identification system 304 can determine that the user is using public transportation for the trip.

The transportation identification system 304 can calculate the speed of the user at one or more points along the trip. Based on this average speed, the transportation identification system 304 can estimate the mode of transportation. For example, a user that is walking will generally travel at a lower rate of speed than a user that is riding a bicycle or driving a vehicle. In some examples, the mode of transportation can be estimated based on user interest data or user-provided data or the stopping patterns associated with the mode of transportation (e.g., if the stops are associated with predetermined stops for public transportation).

Once one or more trips have been selected, the insight generation system 116 can determine the origination point and destination point for the selected trips. As noted above, in situations in which more than one trip is selected, the insight generation system 116 can determine an average or typical origination point and an average or typical destination for the more than one trip. The insight generation system 116 can generate a recommended route from the origination point (or the average origination point) to the destination point (or the average destination point). In some examples, this recommended route can be generated by an existing navigation system (e.g., navigation system 114 in FIG. 1).

In some examples, the cost determination system 306 can generate a plurality of recommended routes from the origination point to the destination point with each generated route using a different mode of transportation. Modes of transportation can include automobiles, public transportation, airplanes, walking, bicycles, or any other mode of transportation that is possible.

Once one or more recommended routes have been generated, the difference determination system 218 can compare the actual route for the one or more trips to the one or more recommended routes to determine whether any of the recommended routes result in a significant improvement in one or more categories. The cost determination system 306 can generate a first cost for the actual route and one or more second costs for one or more recommended routes. Each cost can be generated by selecting a unit of measurement and using that unit of measurement to determine the cost of the route.

Units of measurement can include time elapsed on the trip, distance traveled, cost, calories burned, carbon emissions produced, etc. For example, if the selected unit of measurement is the amount of time elapsed on the trip, the cost can be a representation of the total time estimated for the user to travel from the origination point to the destination point. It should be noted that costs can be calculated based on the conditions that would have existed at the time that the trip was actually taken. Thus, the costs for both the actual trip and the one or more recommended trips can be associated with the same set of conditions. The conditions present in a given geographic area (e.g., the area of the origination and destination point) can be stored in the historic trip information database or another database accessible to the insight generation system.

The cost determination system 306 can select a specific unit of cost measurement for a particular trip or group of trips. In some examples, the most popular cost measurement for a route can be the time needed to traverse the route. As such, the cost determination system 306 can primarily use this measurement to determine the cost of a particular route. In other examples, the insight generation system can select a unit of measurement based on the user for which the insight is being generated.

For example, the cost determination system 306 can access a user profile database that can include user-submitted information, search history information, and a web-browsing history, but only with user permission. By analyzing this information stored in the user profile, the cost determination system 306 can select a unit of measurement of particular interest to a particular user. For example, a given user may be primarily interested in increasing the number of calories burned while traveling a given route. Thus, the cost determination system 306 can focus on measuring costs based on calories burned for that particular user.

The difference determination system 218 can compare the calculated first costs for the actual route with calculated second costs for the one or more recommended routes. As noted above, the mode of transportation associated with the actual route may be different from the mode of transportation associated with one or more of the recommended routes. Thus, the difference determination system 218 can determine a cost difference between the actual route and the one or more recommended routes. A cost difference can be calculated for a plurality of different units of measurement to identify the unit of measurement with the most cost reduction for a recommended route.

The difference determination system 218 can determine whether the cost difference between the actual route and a particular recommended route exceeds a threshold difference value. If the cost difference between the first cost (associated with the actual route) and the second cost (associated with a particular recommended route) does not exceed the threshold difference value, the difference determination system 218 can determine that no insights should be communicated to the user in this case. In another example, the difference determination system 218 can use a different unit of measurement to identify another area in which cost savings can be realized.

In some examples, the insight generation system 116 can determine whether the recommended route is possible for the user to take. For example, a walking route may save a significant amount of carbon and may burn a significant number of additional calories. However, if the time needed to travel the route adds three hours to the total journey time, the insight generation system can disregard the recommended route as non-viable. The mode of transportation for a particular route can limit the degree to which it is considered a viable alternative for the actual route. For this reason, even if the unit of measurement is not the time elapsed during the trip, the insight generation system can discard any recommended routes that increase the total time taken by more than a threshold value (e.g., more than 10 minutes added to a route). Additionally, particular modes of transportation can be ignored for trips that exceed some threshold value. Thus, walking may not be considered for any trip over a certain distance (e.g., 1 mile, 10 miles, or another value) and bicycling may not be considered for any trip over a certain distance (e.g., more than 50 miles).

If the insight generation system 116 determines that a particular recommended route can result in an improvement for one or more units of measurement and remain a viable route, the recommendation system 220 can transmit a message to a computing device associated with the user for display. The message can include information describing one or more cost savings to be expected if the user had used a recommended route rather than the actual route that the user took. In this way, the insight generation system 116 can incentivize users to use the navigation system associated with the insight generation system to plan future trips.

In some examples, the recommendation message can be sent as an email (e.g., as part of a regularly delivered email newsletter). For example, a computer services system associated with the navigation system (e.g., navigation system 114 in FIG. 1) can deliver periodic newsletter emails to users and can include information about potential cost savings within the email. Similarly, the insight navigation system can transmit recommendation messages as text to users such that the message will be displayed on the user's computing device. In addition, a user computing device may include a dedicated navigation application associated with the navigation system. In some examples, the insight information can be displayed to the user when they open the navigation app. In some examples, a user may enter a search associated with one of the more units of measurement into a search engine. In response, the insight generation system can display, as part of one of the search results, a suggested route improvement that will be associated with the search query. For example, if a user submits a search query including the question “how can I reduce my carbon footprint,” the insight generation system can display one or more suggested route alterations that will have the desired effect for the user.

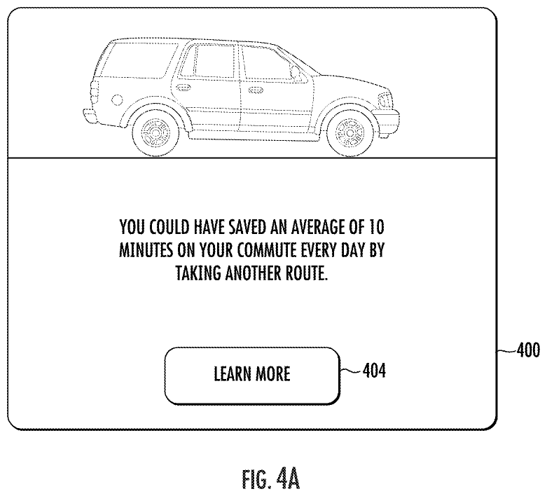

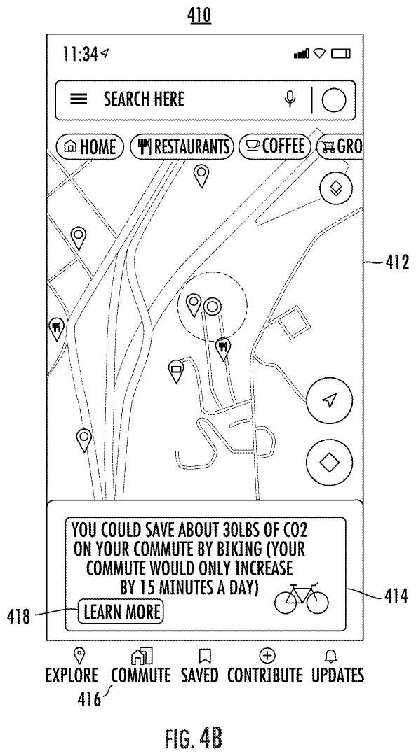

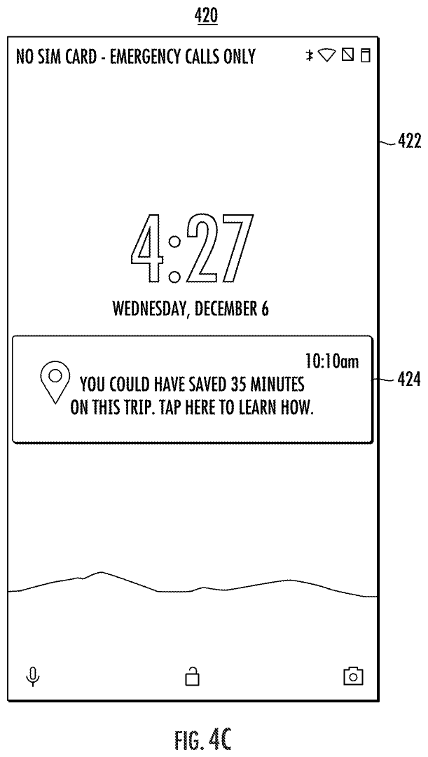

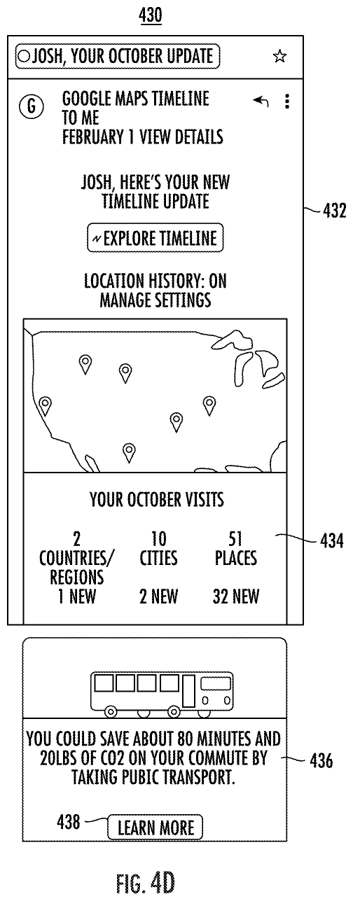

FIG. 4A depicts an example user interface 400 for displaying one or more route improvements to a user according to example aspects of the present disclosure. In this example, an insight (e.g., a suggested route improvement) can be displayed in an interface. The insight can identify a specific trip, a unit of measurement, and the amount that can be saved by following the route suggested by the navigation system (e.g., navigation system 114 in FIG. 1). In this example, the identified trip is a commute, the unit of measurement is time (in minutes), and the amount saved is 10 minutes. This insight can be displayed on a display to a user. The user interface can include a button 404 that links to additional information.

FIG. 4B depicts an example user interface 410 for displaying one or more route improvements to a user according to example aspects of the present disclosure. In this example, a navigation application can display a map interface 412. The map interface 412 can include geographic information and navigation information for a particular geographic area. An insight (e.g., a suggested route improvement) can be displayed in an interface. One or more insights 414 can be displayed in the user interface. In this example, the navigation application includes more than one interface tab. The insight can be displayed in a commute tab 416. The interface can include a button 418 that links to additional information.

The insight 414 can identify a specific trip, a unit of measurement, and the amount that can be saved by following the route suggested by the navigation system (e.g., navigation system 114 in FIG. 1). In this example, the identified trip is a commute, the unit of measurement is an amount of CO₂ in pounds, and the amount saved is 30 pounds. The insight also displays a second unit of measurement to represent an additional cost of the recommended route. In this example, the additional cost is 15 minutes as the route switches from using an automobile to using a bicycle.

FIG. 4C depicts an example user interface 420 for displaying one or more route improvements to a user according to example aspects of the present disclosure. In this example, an insight 424 (e.g., a suggested route improvement) can be displayed in an interface 420. The interface is a lock screen 422 of a smartphone. The insight can specify a unit of measurement and an amount that can be saved by following the route suggested by the navigation system (e.g., navigation system 114 in FIG. 1). In this example, the unit of measurement is time (in minutes) and the amount saved is 35 minutes. This insight can be displayed on a display to a user. The user interface 420 can include a link to additional information.

FIG. 4D depicts an example user interface 430 for displaying one or more route improvements to a user according to example aspects of the present disclosure. In this example, an insight 436 (e.g., a suggested route improvement) can be displayed in an interface 432. In this example, the user interface 432 is associated with a periodic report 434, the periodic report including information about trips taken by a user. The insight 436 can specify a trip, one or more units of measurement, and an amount that can be saved by following the route suggested by the navigation system (e.g., navigation system 114 in FIG. 1). In this example, the specified trip can be a commute, the units of measurement are time (in minutes) and the amount of carbon produced (in pounds). The amount saved can be 80 minutes and 20 pounds of carbon. This insight can be sent as an email message as part of the periodic report and displayed on a display to a user. The user interface can include a link 438 to additional information.

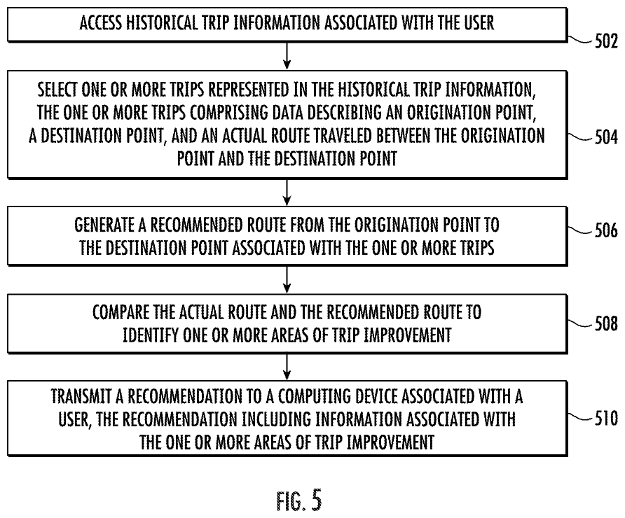

FIG. 5 depict a flowchart illustrating an example method for identifying route improvements for a user according to example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1-2.

The insight generation system (e.g., insight generation system 116 in FIG. 1) can, at 502, access historical trip information associated with the user. In some examples, the historical trip information can be accessed from the historical trip database (e.g., historical trip database 134 in FIG. 1).

In some examples, the insight generation system (e.g., insight generation system 116 in FIG. 1) can, at 504, select one or more trips represented in the historical trip information, the one or more trips comprising data describing an origination point, a destination point, and an actual route traveled between the origination point and the destination point. In some examples, the insight generation system (e.g., insight generation system 116 in FIG. 1) can select a most recent trip associated with the user.

In some examples, the insight generation system (e.g., insight generation system 116 in FIG. 1) can determine a target time period. The insight generation system (e.g., insight generation system 116 in FIG. 1) can identify one or more trips that occurred during the target time period. For example, the insight generation system (e.g., insight generation system 116 in FIG. 1) can select a time associated with commutes (e.g., between 7 AM and 9 AM and between 5 PM and 6 PM). The insight generation system (e.g., insight generation system 116 in FIG. 1) can identify one or more trips that occurred during the selected time periods as possible candidates to be commuting trips.

In some examples, the insight generation system (e.g., insight generation system 116 in FIG. 1) can analyze the historical trip information to identify a commute associated with the user. The insight generation system (e.g., insight generation system 116 in FIG. 1) can select a plurality of trips represented in the historical trip information associated with the commute associated with the user. The insight generation system (e.g., insight generation system 116 in FIG. 1) can calculate an average commute route based on the plurality of trips.

In some examples, the insight generation system (e.g., insight generation system 116 in FIG. 1) can determine, for the one or more trips, a mode of transportation associated with the actual route. The mode of transportation can include one of an automobile, public transportation, walking, and bicycling. In some examples, the mode of transportation can be determined based on the actual route traveled and a speed associated with one or more portions of the actual route.

The insight generation system (e.g., insight generation system 116 in FIG. 1) can generate, at 506, a recommended route from the origination point to the destination point associated with the one or more trips. In some examples, a navigation system (e.g., navigation system 114 in FIG. 1) associated with the insight generation system (e.g., insight generation system 116 in FIG. 1) can generate a recommended route from the origination point to the destination point.

The insight generation system (e.g., insight generation system 116 in FIG. 1) can generate a plurality of recommended routes, each recommended route associated with a different mode of transportation. In some examples, the actual route can be associated with a first mode of transportation and one respective recommended route in the plurality of recommended routes can be associated with a second mode of transportation. In some examples, the first mode of transportation can be different than the second mode of transportation.

In some examples, the insight generation system (e.g., insight generation system 116 in FIG. 1) can access user profile data for the user. The user profile can store information stored about a user including, but not limited to a user's search history, media viewing history, social networking interaction history (e.g., posts, likes, upvotes, and so on), and so on. The insight generation system (e.g., insight generation system 116 in FIG. 1) can determine, based on the user profile data, a first unit of measurement associated with the user.

In some examples, the insight generation system (e.g., insight generation system 116 in FIG. 1) can, at 508, compare the actual route and the recommended route to identify one or more areas of trip improvement. The insight generation system (e.g., insight generation system 116 in FIG. 1) can calculate a first cost associated with the actual route using the first unit of measurement. The insight generation system (e.g., insight generation system 116 in FIG. 1) can calculate a second cost associated with the recommended route using the first unit of measurement. The insight generation system (e.g., insight generation system 116 in FIG. 1) can determine a difference between the first cost and the second cost.

The insight generation system (e.g., insight generation system 116 in FIG. 1) can determine whether the difference between the first cost and the second cost exceeds a predetermined cost threshold. In response to determining that the difference between the first cost and the second cost exceeds a predetermined cost threshold, the insight generation system (e.g., insight generation system 116 in FIG. 1) can select the first unit of measurement as the area of trip improvement.

In response to determining that the difference between the first cost and the second cost does not exceed a predetermined cost threshold, the insight generation system (e.g., insight generation system 116 in FIG. 1) can select a second unit of measurement and measuring the difference between the actual route and at least one recommended route using the second unit of measurement. In some examples, the first unit of measurement is one of distance, cost, time, calories consumed, and carbon produced.

In some examples, the insight generation system (e.g., insight generation system 116 in FIG. 1) can transmit, at 510, a recommendation to a computing device associated with a user, the recommendation including information associated with the one or more areas of trip improvement. The insight generation system (e.g., insight generation system 116 in FIG. 1) can transmit an electronic message to a computing system associated with the user for display.

The insight generation system (e.g., insight generation system 116 in FIG. 1) can transmit the recommendation for display in a navigation application running on a computing device associated with the user. In some examples, the recommendation can be transmitted in response to a search query received from the computing device associated with the user.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and/or equivalents to such embodiments. Accordingly, the subject disclosure does not preclude inclusion of such modifications, variations, and/or additions to the present subject matter as would be readily apparent to one of ordinary skill in the art. For instance, features illustrated and/or described as part of one embodiment can be used with another embodiment to yield a still further embodiment. Thus, it is intended that the present disclosure cover such alterations, variations, and/or equivalents.

What is claimed is:

1. A computer-implemented method for identifying route improvements for a user, the method comprising:
accessing, by a computing system comprising one or more processors, historical trip information associated with the user;
selecting, by the computing system, one or more trips represented in the historical trip information, the one or more trips comprising data describing an origination point, a destination point, and an actual route traveled between the origination point and the destination point;
generating, by the computing system, a recommended route from the origination point to the destination point associated with the one or more trips;
comparing, by the computing system, the actual route and the recommended route to identify one or more areas of trip improvement; and
transmitting, by the computing system, a recommendation to a computing device associated with a user, the recommendation including information associated with the one or more areas of trip improvement.

2. The computer-implemented method of claim 1, wherein selecting, by the computing system, one or more trips represented in the historical trip information further comprises:
selecting, by the computing system, a most recent trip associated with the user.

3. The computer-implemented method of claim 1, wherein selecting, by the computing system, one or more trips represented in the historical trip information further comprises:
determining, by the computing system, a target time period; and
identifying, by the computing system, one or more trips that occurred during the target time period.

4. The computer-implemented method of claim 1, wherein selecting, by the computing system, one or more trips represented in the historical trip information further comprises:
analyzing, by the computing system, the historical trip information to identify a commute associated with the user;
selecting, by the computing system, a plurality of trips represented in the historical trip information associated with the commute associated with the user; and
calculating, by the computing system, an average commute route based on the plurality of trips.

5. The computer-implemented method of claim 1, further comprising:
determining, by the computing system and for the one or more trips, a mode of transportation associated with the actual route.

6. The computer-implemented method of claim 5, wherein the mode of transportation includes one of an automobile, public transportation, walking, and bicycling.

7. The computer-implemented method of claim 5, wherein the mode of transportation is determined based on the actual route traveled and a speed associated with one or more portions of the actual route.

8. The computer-implemented method of claim 1, wherein a recommended route from the origination point to the destination point associated with the one or more trips further comprises:
generating, by the computing system, a plurality of recommended routes, each recommended route associated with a different mode of transportation.

9. The computer-implemented method of claim 8, wherein the actual route is associated with a first mode of transportation and one respective recommended route in the plurality of recommended routes is associated with a second mode of transportation.

10. The computer-implemented method of claim 9, wherein the first mode of transportation is different from the second mode of transportation.

11. The computer-implemented method of claim 8, wherein generating, by the computing system, a recommended route from the origination point to the destination point further comprises:
accessing, by the computing system, user profile data for the user; and
determining, by the computing system and based on the user profile data, a first unit of measurement associated with the user.

12. The computer-implemented method of claim 11, wherein comparing, by the computing system, the actual route and the recommended route to identify one or more areas of trip improvement further comprises:
calculating, by the computing system, a first cost associated with the actual route using the first unit of measurement;
calculating, by the computing system, a second cost associated with the recommended route using the first unit of measurement; and
determining, by the computing system, a difference between the first cost and the second cost.

13. The computer-implemented method of claim 12, wherein comparing, by the computing system, the actual route and the recommended route to identify one or more areas of trip improvement further comprises:
determining, by the computing system, whether the difference between the first cost and the second cost exceeds a predetermined cost threshold; and
in response to determining that the difference between the first cost and the second cost exceeds a predetermined cost threshold, selecting, by the computing system, the first unit of measurement as the area of trip improvement.

14. The computer-implemented method of claim 13, further comprising:
in response to determining that the difference between the first cost and the second cost does not exceed a predetermined cost threshold, selecting, by the computing system, a second unit of measurement and measuring the difference between the actual route and at least one recommended route using the second unit of measurement.

15. The computer-implemented method of claim 11, wherein the first unit of measurement is one of distance, cost, time, calories consumed, and carbon produced.

16. The computer-implemented method of claim 1, wherein transmitting, by the computing system, a recommendation for display to a user including information associated with the one or more areas of trip improvement further comprises:
transmitting, by the computer system, an electronic message to a computing system associated with the user for display.

17. The computer-implemented method of claim 1, wherein transmitting, by the computing system, a recommendation for display to a user including information associated with the one or more areas of trip improvement further comprises:
transmitting, by the computer system, the recommendation for display in a navigation application running on a computing device associated with the user.

18. The computer-implemented method of claim 1, wherein the recommendation is transmitted in response to a search query received from the computing device associated with the user.

19. A system for identifying route improvements for a user, the system comprising:
a computing system comprising one or more processors and a non-transitory computer-readable memory;
wherein the non-transitory computer-readable memory stores instructions that, when executed by the one or more processors, cause the computing system to perform operations, the operations comprising:
accessing historical trip information associated with the user;
selecting one or more trips represented in the historical trip information, the one or more trips comprising data describing an origination point, a destination point, and an actual route traveled between the origination point and the destination point;
generating a recommended route from the origination point to the destination point;
comparing the actual route and the recommended route to identify one or more areas of trip improvement; and
transmitting a recommendation for display to a user including information associated with the one or more areas of trip improvement.

20. A non-transitory computer-readable medium storing instruction that, when executed by one or more computing devices, cause the one or more computing devices to perform operations, the operations comprising:
accessing historical trip information associated with a user;
selecting one or more trips represented in the historical trip information, the one or more trips comprising data describing an origination point, a destination point, and an actual route traveled between the origination point and the destination point;
generating a recommended route from the origination point to the destination point;
comparing the actual route and the recommended route to identify one or more areas of trip improvement; and
transmitting a recommendation for display to a user including information associated with the one or more areas of trip improvement.
